(19) United States
(12) Patent Application Publication
(10) Pub. No.: US 2016/0087384 A1
(43) Pub. Date: Mar. 24, 2016

(54) USB and Micro USB T-Tip Connectors

(71) Applicant: Seth GREEN, Brooklyn, NY (US)

(72) Inventor: Seth GREEN, Brooklyn, NY (US)

(21) Appl. No.: 14/852,404

(22) Filed: Sep. 11, 2015

Related U.S. Application Data
(60) Provisional application No. 62/049,836, filed on Sep. 12, 2014.

(51) Int. Cl. H01R 24/60

(52) U.S. Cl. CPC H01R 24/60; H01R 2107/00

(57) ABSTRACT

A USB and a Micro USB connector having an inner T shape structure that permits connection between wires, cables and devices is provided; wherein a male tip (10) connector has an extension (3) and a hollow inner T shape structure (1) surrounded by solid space (2) and a female tip (8) connector has a solid inner T shape structure (5) surrounded by open space (6).

This application claims the benefit of U.S. provisional application No. 62/049,836 filed Sep. 12, 2014, which is incorporated herein in its entirety by reference.

### FIELD OF THE INVENTION

The present invention relates to a USB “A” and Micro USB T-tip connectors. More particularly, the invention T-tips are used as plugs and receptacles for connecting devices requiring proprietary wires and adaptors.

### BACKGROUND OF THE INVENTION

Universal Serial Bus (USB) was developed in the 1990s in an effort to simplify the connections between computers and peripheral devices. It has become widely popular due to its compatibility with many platforms and operating systems, its low cost of implementation, and its ease of use. Most computers that are built today come with several USB ports, and USB is the interface of choice for most home and office peripherals including printers, cameras, modems, and portable storage devices.

USB was also designed to standardize the connection of computer peripherals (including keyboards, pointing devices, digital cameras, printers, portable media players, disk drives and network adapters) to personal computers, both to communicate and to supply electric power. It has become commonplace on other devices, such as smart phones, PDAs and video game consoles. USB has effectively replaced a variety of earlier interfaces, such as serial and parallel ports, as well as separate power chargers for portable devices.

In general, there are three basic kinds or sizes related to the USB connectors and types of established connection: the older “standard” size, in its USB 1.1, 2.0, and 3.0 variants (for example, on USB flash drives), the “mini” size (primarily for the B connector end, such as on many cameras), and the “micro” size, in its USB 1.1, 2.0, and 3.0 variants (for example, on most modern mobile phones).

Unlike other data cables (e.g. Ethernet, HDMI), each end of a USB cable uses a different kind of connector; a Type-A or a Type-B. This kind of design was chosen to prevent electrical overloads and damaged equipment, as only the Type-A socket provides power. There are cables with Type-A connectors on both ends, but they should be used carefully.^{[4]} Therefore, in general, each of the different “sizes” requires four different connectors; USB cables have the Type-A and Type-B plugs, and the corresponding receptacles are on the computer or electronic device. In common practice, the Type-A connector is usually the full size, and the Type-B side can vary as needed.

The mini and micro sizes also allow for a reversible Type-AB receptacle, which can accept either a Type-A or a Type-B plug. This scheme, known as “USB On-The-Go”, allows one receptacle to perform its double duty in space-constrained applications.

Counter-intuitively, the “micro” size is the most durable from the point of designed insertion lifetime. The standard and mini connectors were designed for less than daily connections, with a design lifetime of 1,500 insertion-removal cycles. (Improved mini-B connectors have reached 5,000-cycle lifetimes.) Micro connectors were designed with frequent charging of portable devices in mind; not only is design lifetime of the connector improved to 10,000 cycles, but it was also redesigned to place the flexible contacts, which wear out sooner, on the easily replaced cable, while the more durable rigid contacts are located in the micro-USB receptacles. Likewise, the springy part of the retention mechanism (parts that provide required gripping force) were also moved into plugs on the cable side.

USB connections also come in five data transfer modes, in ascending order: Low Speed, Full Speed, High Speed (2.0), SuperSpeed (3.0), and SuperSpeed+ (3.1). High Speed is supported only by specifically designed USB 2.0 High Speed interfaces (that is, USB 2.0 controllers without the High Speed designation do not support it), as well as by USB 3.0 and newer interfaces. SuperSpeed is supported only by USB 3.0 and newer interfaces, and requires a connector and cable with extra pins and wires, usually distinguishable by the blue inserts in connectors.

USB standards are developed and maintained by an industry body called the USB Implementers Forum (USB-IF). In its original specification, USB defined only two connector types: A and B. Revisions to the specification and demands on manufacturers have expanded the breadth of connectors used for USB devices, but the majority of USB products still use these A and B connector interfaces. The various USB types recognized by the USB-IF are described below.

USB A-Type

Found on host controllers in computers and hubs, the A-style connector is a flat, rectangular interface. This interface holds the connection in place by friction which makes it very easy for users to connect and disconnect. Instead of round pins, the connector uses flat contacts which can withstand continuous attachment and removal very well. The A-socket connector provides a “downstream” connection that is intended for use solely on host controllers and hubs. It was not intended for use as an “upstream” connector on a peripheral device. This is critical because a host controller or hub is designed to provide 5V DC power on one of the USB pins. Though not that common, A-A cables are used to connect USB devices with an A-style Female port to a PC or another USB device, and for data transfer between two computer systems. Note: Typically an A-A cable is not intended to connect two computers together or to connect a USB hub between two computers. Doing so may cause irreparable damage to your computers and may even present a fire hazard. Before using an A-A cable for data transfer one should check with the manufacturer.

USB B-Type

The B-style connector is designed for use on USB peripheral devices. The B-style interface is squarish in shape, and has slightly beveled corners on the top ends of the connector. Like the A connector, it uses the friction of the connector body to stay in place. The B-socket is an “upstream” connector that is only used on peripheral devices. Because of this, the majority of USB applications require an A-B cable.

USB C-Type

The USB-C or USB Type-C connector is the newest USB connector on the market. The USB-C connector has a reversible/symmetrical design and can be plugged into any USB-C device using either end. A USB-C cable is capable of carrying USB 3.1, USB 3.0, USB 2.0, and USB 1.1 signals. The USB-C is commonly paired with the USB-A, USB-B, USB Micro-B, and other USB connectors when supporting previous versions of the USB specification. USB-C can be adapted to work with each of these legacy connectors. When connecting two USB 3.1 devices, the USB-C cable will support data transfer rates that are twice the speed of existing USB technology (up to 10 Gbit/s), enhanced power delivery of up to 20 volts, 5 amps, and 100 watts for power and charging, and built-in support for Display Port video and four channel audio (speaker and microphone).

Micro-USB A

This connector can be found on newer mobile devices such as cell phones, GPS units, PDAs and digital cameras. Micro-USB A offers a connection physically smaller in size to a USB Mini-b, while still supporting the high speed transfer rate of 480 Mbps and On-The-Go features. The connection can be easily identified by its white-colored receptacle and compact 5 pin design.

Micro-USB B

This connector can also be found on newer mobile devices such as cellphones, GPS units, PDAs and digital cameras. Micro-USB B offers a connection physically smaller in size to a USB Mini-b, while still supporting the high speed transfer rate of 480 Mbps and On-The-Go features. The connection can be easily identified by its black-colored receptacle and compact 5 pin design

Micro-USB AB

Designed exclusively for USB On-The-Go devices, this versatile connector can accept either a Micro-USB A or Micro-USB B cable connection. This interface can be easily identified by its gray-colored receptacle and compact 5 pin design. This connector type only exists as a receptacle for On-The-Go devices and will not exist on a cable.

USB Mini-b (5 Pin)

One drawback to the B-style connector is its size, which measures almost a half inch on each side. This made the B-style interface unsuitable for many compact personal electronic devices such as PDAs, digital cameras, and cellphones. As a result, many device manufacturers began the miniaturization of USB connectors with this Mini-b. This 5-pin Mini-b is the most popular style of Mini-b connector, and the only one recognized by the USB-IF. By default, a Mini-b cable is presumed to have 5 pins. This connector is quite small, about two-thirds the width of an A-style connector. It is also specified for use in the newer standard called USB On-The-Go which allows peripheral devices to communicate with the presence of a host controller.

USB Mini-b (4 Pin)

Instead of the typical 5-pin Mini-b, this unofficial connector is found on many digital cameras, especially certain Kodak® models. It resembles the shape of a standard B-style connector, with beveled corners; however it is much smaller in size.

USB Mini b (Fuji®).

This is another unofficial connector also widely used on digital cameras especially certain models manufactured by Fuji®. It more closely resembles an A-style connector with its flat, rectangular shape.

USB 3.0 A-Type

Known as “SuperSpeed”, this A-style connector is commonly found on host controllers in computers and hubs, the A-style connector is a flat, rectangular interface. This interface holds the connection in place by friction which makes it very easy for users to connect and disconnect. Instead of round pins, the connector uses flat contacts which can withstand continuous attachment and removal very well. The A-socket connector provides a “downstream” connection that is intended for use solely on host controllers and hubs. This connector is similar in size and shape to the A-Type connector used in USB 2.0 & USB 1.1 applications. However, the USB 3.0 A-type has additional pins that are not found in the USB 2.0 & USB 1.1 A-Type. The USB 3.0 connector is designed for USB Super Speed applications; however, it will carry data from slower speed connections, and it is backwards compatible with USB 2.0 ports. USB 3.0 A connectors are often blue in color to help identify them from previous versions.

The USB 3.0 B-Type connector is found on USB 3.0 devices. This connector is designed to carry data and power in USB SuperSpeed applications. Cables with this connector are not backwards compatible with USB 2.0 or USB 1.1 devices; however USB 3.0 devices with this connection type can accept previous USB 2.0 and 1.1 cabling.

The USB 3.0 Micro B connector is found on USB 3.0 devices. This connector is designed to carry data and power in USB SuperSpeed applications. Cables with this connector are not backwards compatible with USB 2.0 or USB 1.1 devices.

The invention provides USB A and Micro USB T-Tips so that proprietary devices are charged using specifically configure wires and charging adaptors.

A USB A cable is the rectangular end to a wire that fits into a computer port/charging adaptor.

The Micro USB is for modern devices used to charge cell phones, cameras, etc.

The advantage of the invention is to provide a USB and Micro USB T-tip so that only proprietary cable wires can be used to charge these devices.

### SUMMARY OF THE INVENTION

In the present invention, these purposes, as well as others which will be apparent, are achieved generally by providing USB A and Micro USB tips having a specific T shape structure. There are male and female tips for connecting wires and devices. The Micro USB is smaller than the USB A which is the portion of the cable that is plugged into the charger itself.

The USB A tip connector of the invention has an inner T shape structure that permits connection between wires, cables and devices. In a male tip (10) the connector has an extension (3) and a hollow inner T shape structure (1) surrounded by solid space (2). In a female tip (8) the connector has a solid inner T shape structure (5) surrounded by open space (6).

The male tip connector extension has two clips (4) on a surface thereon. The female tip has two openings (7) for securing clips (4) of said male tip. The female tip fits securely within said male tip.

The USB A tip connector can be a plug or receptacle.

The invention also provides a Micro USB tip connector having an inner T shape structure that permits connection between wires, cables and devices.

The Micro USB tip connector may be a male tip having an extension and a hollow inner T shape structure. Alternatively, the Micro USB tip connector may be a female tip having solid inner T shape structure surrounded by open space. The female tip fits securely within said male tip.

The Micro USB tip connector can be a plug or a receptacle.

The male tip has an inner T shape space which fits the female tip which has an inner solid T shape. These connectors fit each other. They are also attached to proprietary wires or cable to fit into proprietary devices.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 illustrates the frontal view of the micro USB tip male;

FIG. 2 illustrates a 3D rendering of the micro USB tip, male and female;

FIGS. 3 and 4 illustrates a 3D rendering of the micro USB tip, male and female, left and right side respectively;

FIG. 5 illustrates a 3D rendering of the micro USB tip, male, attached to a cable; and

FIG. 6 illustrates a frontal view of a USB T-tip male.

### DETAILED DESCRIPTION OF THE INVENTION

The following legend is used in the specification to refer to the structures that are illustrated in the drawings.
1—hollow T space
2—solid space
3—extension of USB tip male
4—clips to connect male to female and secure in place
5—solid T on USB T tip female including four indentations, two on each side
6—hollow inner space within the USB T tip female connector
7—open holes that are large enough to snuggly fit clips (4)
8—USB tip female
10—USB tip male
11—Micro USB tip male
12—Cable
13—USB T tip male

The above structures relate to both the USB and Micro USB T tip connectors. In general the Micro USB is much smaller in size than the USB.

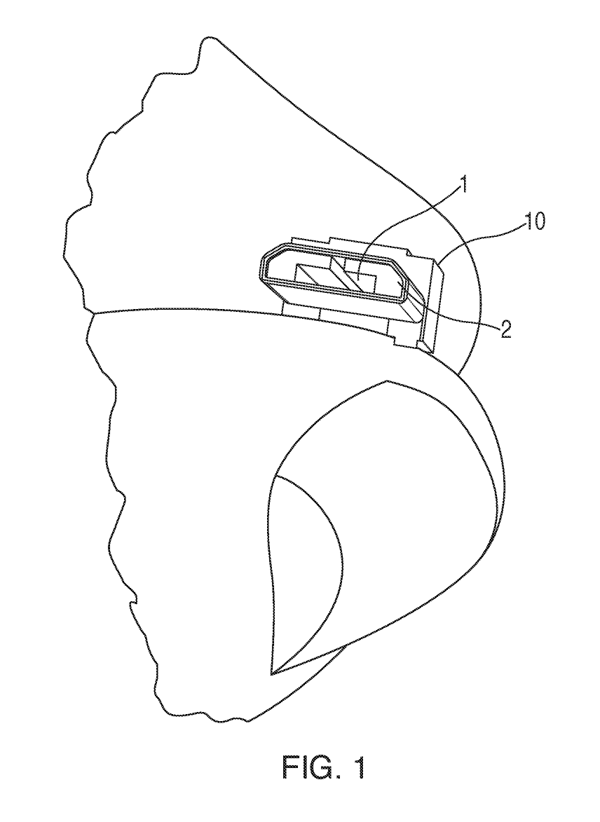

In accordance with the invention, and as illustrated in FIG. 1, a micro USB T-tip is provided. The USB A tip connector of the invention has an inner T shape structure that permits connection between wires, cables and devices. In a male tip (10) the connector has an extension (3) and a hollow inner T shape structure (1) surrounded by solid space (2). In a female tip (8) the connector has a solid inner T shape structure (5) surrounded by open space (6).

The male tip connector extension has two clips (4) on a surface thereon. The female tip has two openings (7) for securing clips (4) of said male tip. The female tip fits securely within said male tip.

The USB A tip connector can be a plug or receptacle.

The invention also provides a Micro USB tip connector having an inner T shape structure that permits connection between wires, cables and devices.

The Micro USB tip connector may be a male tip having an extension and a hollow inner T shape structure. Alternatively, the Micro USB tip connector may be a female tip having solid inner T shape structure surrounded by open space. The female tip fits securely within said male tip.

The Micro USB tip connector can be a plug or a receptacle.

The male tip has an inner T shape space which fits the female tip which has an inner solid T shape. These connectors fit each other. They are also attached to proprietary wires or cable to fit into proprietary devices.

The connector mounted on the host or device is called the receptacle, and the connector attached to the cable is called the plug. The official USB specification documents also periodically define the term male to represent the plug, and female to represent the receptacle (USB 2.0 Specification Engineering Change-USB.org” (PDF). USB Flash Drive Alliance. Retrieved 2014 Dec. 29).

By design, it is difficult to insert a USB plug into its receptacle incorrectly. In Hewlett-Packard, Intel, Microsoft, NEC, ST-Ericsson, Texas Instruments (6 Jun. 2011). Universal Serial Bus 3.0 Specification: Revision 1.0. p. 531. Retrieved 2011 July 26, the USB specification states that the required USB icon must be embossed on the “topside” of the USB plug, which “ . . . provides easy user recognition and facilitates alignment during the mating process.” The specification also shows that the “recommended” “Manufacturer's logo” (“engraved” on the diagram but not specified in the text) is on the opposite side of the USB icon. The specification further states, “The USB Icon is also located adjacent to each receptacle. Receptacles should be oriented to allow the icon on the plug to be visible during the mating process.” However, the specification does not consider the height of the device compared to the eye level height of the user, so the side of the cable that is “visible” when mated to a computer on a desk can depend on whether the user is standing or kneeling.

While connector interfaces can be designed to allow plugging with either orientation, the original design omitted such functionality to decrease manufacturing costs. Ajay Bhatt, who was involved in the original USB design team, is working on a new design to make the cable insertable either side up.^{[59]} The new reversible Type-C plug is an addition to the USB 3.1 specification; it is much smaller than the current USB 3.0 micro-B connector.

Only moderate force is needed to insert or remove a USB cable. USB cables and small USB devices are held in place by the gripping force from the receptacle (without need of the screws, clips, or thumb-turns other connectors have required

The standard connectors were deliberately intended to enforce the directed topology of a USB network: type A receptacles on host devices that supply power and type B receptacles on target devices that draw power. This is intended to prevent users from accidentally connecting two USB power supplies to each other, which could lead to short circuits and dangerously high currents, circuit failures, or even fire. USB does not support cyclic networks and the standard connectors from incompatible USB devices are themselves incompatible.

However, some of this directed topology is lost with the advent of multi-purpose USB connections (such as USB On-The-Go in smartphones, and USB-powered Wi-Fi routers), which require A-to-A, B-to-B, and sometimes Y/splitter cables.

The standard connectors were designed to be robust. Because USB is hot-pluggable, the connectors would be used more frequently and perhaps with less care, than other connectors. Many previous connector designs were fragile, specifying embedded component pins or other delicate parts that were vulnerable to bending or breaking. The electrical contacts in a USB connector are protected by an adjacent plastic tongue, and the entire connecting assembly is usually protected by an enclosing metal sheath.

The connector construction always ensures that the external sheath on the plug makes contact with its counterpart in the receptacle before any of the four connectors within make electrical contact. The external metallic sheath is typically connected to system ground, thus dissipating damaging static charges. This enclosure design also provides a degree of protection from electromagnetic interference to the USB signal while it travels through the mated connector pair (the only location when the otherwise twisted data pair travels in parallel). In addition, because of the required sizes of the power and common connections, they are made after the system ground but before the data connections. This type of staged make-break timing allows for electrically safe hot-swapping.

The newer micro-USB receptacles are designed for up to 10,000 cycles of insertion and removal between the receptacle and plug, compared to 1,500 for the standard USB and 5,000 for the mini-USB receptacle. To accomplish this, a locking device was added and the leaf-spring was moved from the jack to the plug, so that the most-stressed part is on the cable side of the connection. This change was made so that the connector on the less expensive cable would bear the most wear instead of the more expensive micro-USB device.

The USB standard specifies relatively loose tolerances for compliant USB connectors to minimize physical incompatibilities in connectors from different vendors. To address a weakness present in some other connector standards, the USB specification also defines limits to the size of a connecting device in the area around its plug. This was done to prevent a device from blocking adjacent ports due to the size of the cable strain relief mechanism (usually molding integral with the cable outer insulation) at the connector. Compliant devices must either fit within the size restrictions or support a compliant extension cable that does.

In general, USB cables have only plugs on their ends, while hosts and devices have only receptacles. Hosts almost universally have Type-A receptacles, while devices have one or another Type-B variety. Type-A plugs mate only with Type-A receptacles, and the same applies to their Type-B counterparts; they are deliberately physically incompatible. However, an extension to the USB standard specification called USB On-The-Go (OTG) allows a single port to act as either a host or a device, what is selectable by the end of the cable that plugs into the receptacle on the OTG-enabled unit. Even after the cable is hooked up and the units are communicating, the two units may “swap” ends under program control. This capability is meant for units such as PDAs in which the USB link might connect to a PC's host port as a device in one instance, yet connect as a host itself to a keyboard and mouse device in another instance.

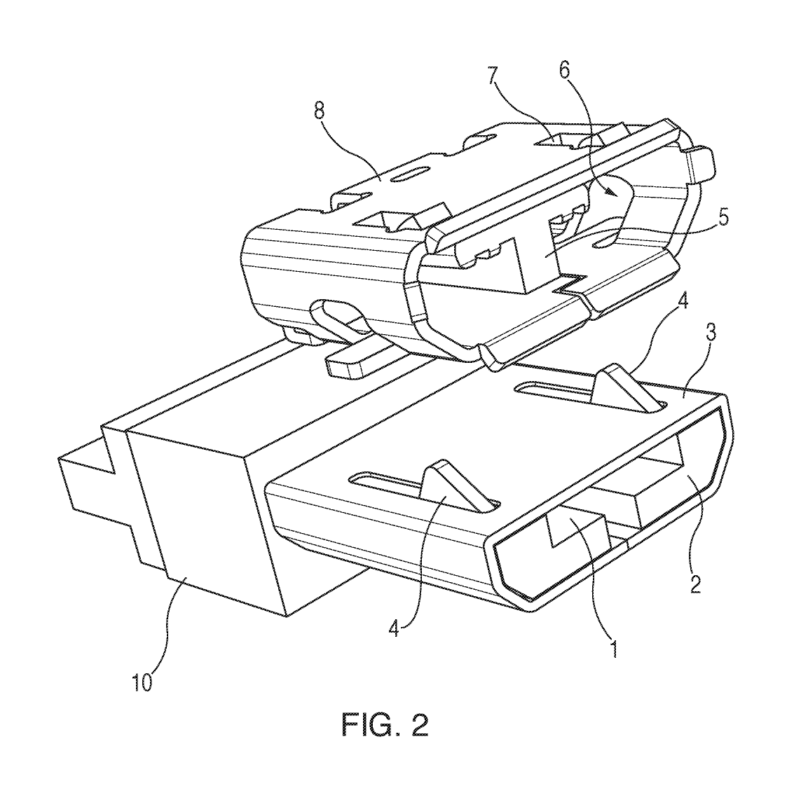

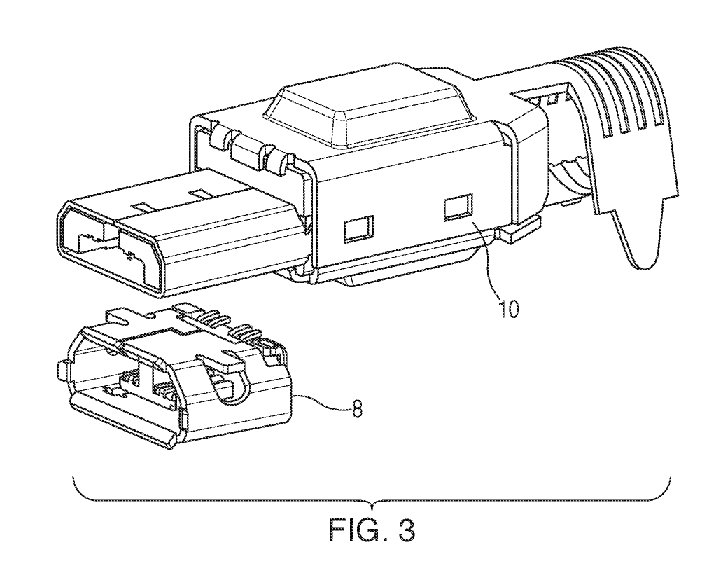

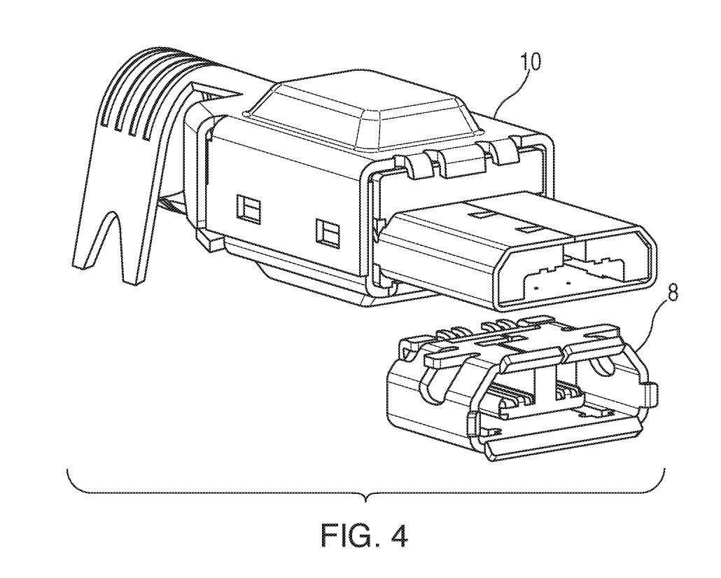

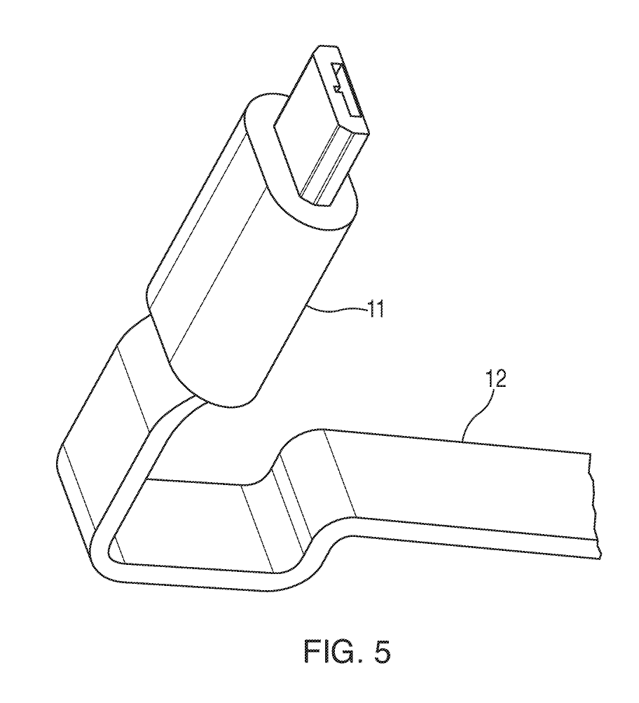

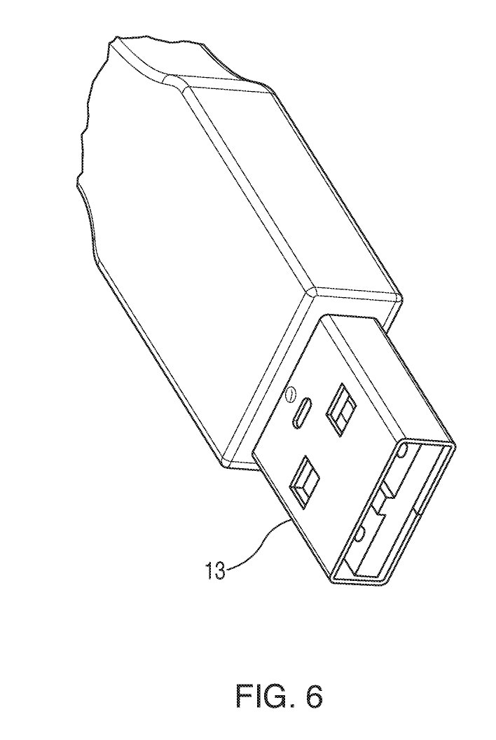

In a preferred embodiment a USB A wire with a micro tip is provided. Both ends of the wire, USB “A” and Micro USB have a specific T tip connector on the male and female inputs and outputs. All FIGS. 1 to 6 show this embodiment.

This configuration permits only proprietary wires to fit into the specific devices.

The T tip will stop any product from being used with proprietary wires that do not have these specified tips. The devices that have the invention t-tip ports will not be able to be charged without a wire that will fit them.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A USB A tip connector having an inner T shape structure that permits connection between wires, cables and devices.

2. The USB A tip connector according to claim 1, wherein the connector is a male tip (10) having an extension (3) and a hollow inner T shape structure (1) surrounded by solid space (2).

3. The USB A tip connector according to claim 1, wherein the connector is a female tip (8) having solid inner T shape structure (5) surrounded by open space (6).

4. The USB A tip connector according to claim 2, wherein said extension has two clips (4) on a surface thereon.

5. The USB A tip connector according to claim 3, wherein said female tip fits securely within said male tip.

6. The USB A tip connector according to claim 3, wherein said female tip has two openings (7) for securing clips (4) of said male tip.

7. The USB A tip connector according to claim 1, wherein said connector is a plug.

8. The USB A tip connector according to claim 1, wherein said connector is a receptacle.

9. A Micro USB tip connector having an inner T shape structure that permits connection between wires, cables and devices.

10. The Micro USB tip connector according to claim 9, wherein the connector is a male tip having an extension and a hollow inner T shape structure.

11. The Micro USB tip connector according to claim 9, wherein the connector is a female tip having solid inner T shape structure surrounded by open space.

12. The Micro USB tip connector according to claim 11, wherein said female tip fits securely within said male tip.

13. The Micro USB tip connector according to claim 9, wherein said connector is a plug.

14. The Micro USB tip connector according to claim 9, wherein said connector is a receptacle.
